(19) United States
(12) Patent Application Publication
(10) Pub. No.: US 2005/0289254 A1
(43) Pub. Date: Dec. 29, 2005

(54) Dynamic buffer allocation method

(76) Inventor: Chih-Feng Chien, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/878,076

(22) Filed: Jun. 28, 2004

(51) Int. Cl. G06F 13/14

(52) U.S. Cl. 710/52

(57) ABSTRACT

A dynamic allocation method for DMA buffers. A DMA controller is directed to move data from an input/output (I/O) device to buffers linked in a buffer ring. Next, free buffers in the buffer ring are detected when the each buffer is full. At least one new buffer is then allocated to the buffer ring when the number of detected free buffers is less than a first threshold value. Further, at least one buffer is released from the buffer ring when the number of detected free buffers exceeds a second threshold value, wherein the second threshold value exceeds the first threshold value, and the free buffers are all buffers in the buffer ring excluding those with data moved thereto by the DMA controller not yet processed by the CPU.

### BACKGROUND

The invention relates to a buffer allocation method, and more particularly, to a dynamic buffer allocation method, and an electronic device using the same.

In conventional directly memory access (DMA) allocation mechanisms, a certain portion of the buffer is allocated by a processor, and a DMA controller can move data from an I/O device to the allocated buffer when the I/O device requests a DMA transfer.

The processor, however, is required to stop DMA controller from moving data when the allocated buffer is full, resulting in a data transfer interrupt. To address this problem, a chained DMA buffer allocation mechanism has been disclosed. In this mechanism, the processor allocates several buffers for the DMA controller. The buffers are linked sequentially, and the final buffer is links to the first to from a ring. Thus, when one buffer is full, the DMA controller can move data to the next buffer in the ring, such that there is no need to stop the DMA controller from moving data when one buffer reaches capacity. In chained DMA buffer allocation mechanism, however, some data may be overwritten by new data when processor cannot processes data as fast as the DMA controller moves data to the buffers.

### SUMMARY

Embodiments of the invention allocate buffers dynamically for DMA transfers thereby preventing data transfer interrupt of conventional buffer allocation method, thus, improving memory utilization.

Embodiments of the invention provide a dynamic allocation method for DMA buffers. In the method, a DMA controller is directed to move data from an input/output (I/O) device to buffers linked in a buffer ring. Next, free buffers in the buffer ring are detected when each preceding buffer is full. At least one new buffer is then allocated to the buffer ring when the number of detected free buffers is less than a first threshold value. Further, at least one buffer is released from the buffer ring when the number of detected free buffers exceeds a second threshold value, wherein the second threshold value exceeds the first threshold value.

Embodiments of the invention provide an electronic device capable of allocating DMA buffers dynamically. In the electronic device, a memory stores an allocation table with a plurality of buffer records, wherein each buffer record relates to a corresponding buffer in memory and comprises the address and the size of the corresponding buffer and a point linked to the next record. A DMA controller transfers data between the buffers and an input/output (I/O) device according to the allocation table and outputs a first interrupt when the each buffer in the memory is full. A buffer controller detects free buffers recorded in the allocation table when receiving the first interrupt and adds at least one buffer record into the allocation table when the number of detected free buffers is less than a first threshold value.

### BRIEF DESCRIPTION OF THE DRAWINGS

Embodiments of the invention can be more fully understood by the subsequent detailed description and examples with reference made to the accompanying drawings, wherein:

FIG. 1 is a schematic diagram of the electronic device according to a first embodiment of the invention;

FIG. 2 is a flowchart of the dynamic buffer allocation method according to the first embodiment of the invention;

FIG. 3 is a schematic diagram of the electronic device according to a second embodiment of the invention; and

FIG. 4 is a flowchart of the dynamic buffer allocation method according to the second embodiment of the invention.

### DETAILED DESCRIPTION

### First Embodiment

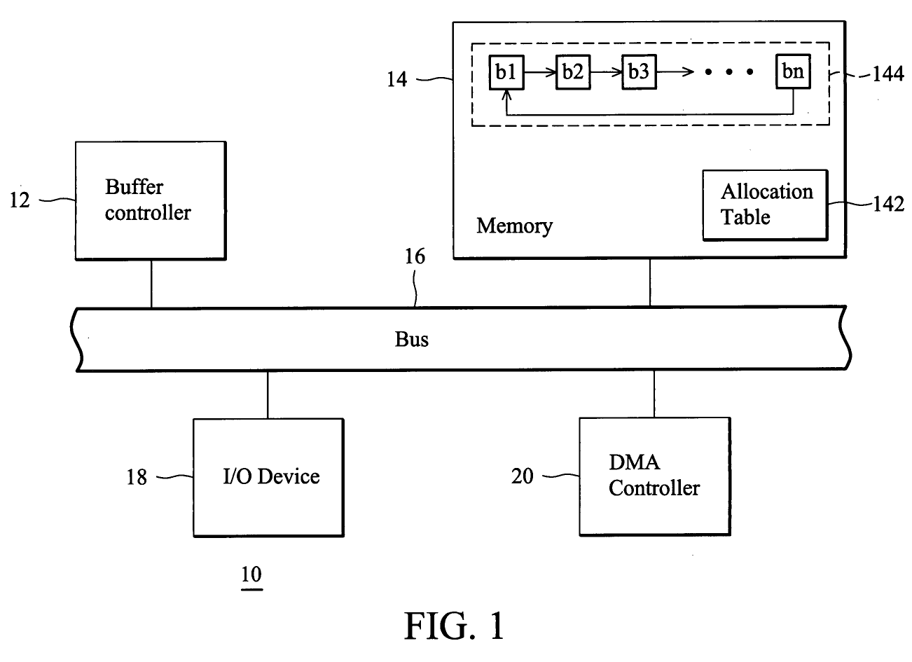

FIG. 1 is a schematic diagram of an electronic device according to a first embodiment of the invention. As shown in FIG. 1, the electronic device 10 comprises a buffer controller 12, a memory 14, a bus 16, and a DMA controller 20. The electronic device 10, for example, can be a mobile phone, a personal digital assistant (PDA) and the like. The input/output (I/O) device 18 is coupled to the bus 16 through an universal serial bus (USB) interface, a network interface, an IrDA (Infrared Data Association) interface and the like. The bus 16 is coupled to the buffer controller 12, the memory 14, the DMA controller 20, and the I/O device 18.

In this embodiment, the buffer controller 12 can be a processor, a central processing unit (CPU), an integrated circuit or similar. The buffer controller 12 dynamically allocates buffers for DMA controller 20 to execute DMA transfers. The DMA controller 20 controls data transfer between the memory 14 and an input/output (I/O) device 18 according to an allocation table 142 in the memory 14.

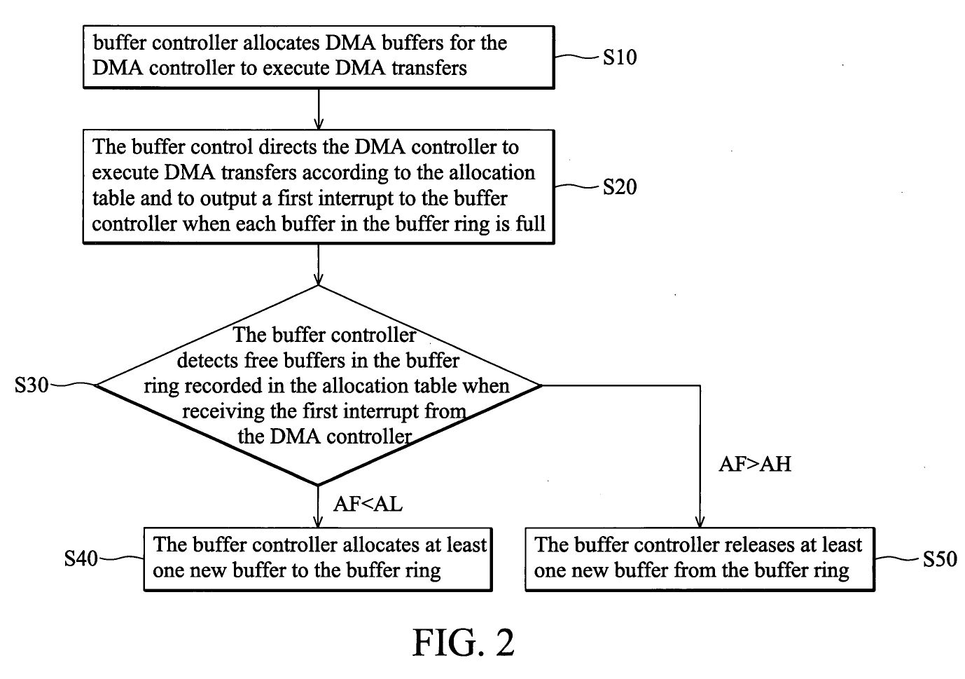

FIG. 2 is a flowchart of the dynamical allocation method for DMA buffers according to the first embodiment of the invention. The allocation method is described in the following, with reference to FIGS. 1 and 2.

In step S10, the buffer controller 12 allocates DMA buffers for the DMA controller 20 to execute DMA transfers. In this embodiment, the buffer controller 12 creates an allocation table 142 and stores into the memory 14 to allocate buffers, such as buffers b1˜bn, for DMA controller 20. The allocation table 142 comprises buffer records with addresses and size of the buffers b1˜bn allocated by the buffer controller 12, and in the allocation table 142 the allocated buffers b1˜bn are linked in a buffer ring 144. For example, the allocation table 142 comprises chain descriptors, and each descriptor corresponds to a buffer in the memory 14. Each descriptor is a data block that describes a DMA transfer, such as the number of data to move, the source and destination addresses, a pointer to the next record and the like. Note that the invention is not limited to the disclosed embodiments. As buffers b1˜bn are linked in the buffer ring 144, when the DMA controller 20 receives a DMA request, the DMA controller 20 can move data to the buffer b2 when the buffer b1 is full, and then move data to the buffer b3 when the buffer b2 is full, and so on. Further, the DMA controller move data to the buffer b1 when the buffer bn is full.

Next, in step S20, the buffer control 12 directs the DMA controller 20 to execute DMA transfers according to the allocation table 142 and to output a first interrupt to the buffer controller 12 when each buffer (b1˜bn) in the buffer ring 144 is full. According to the buffer descriptors in allocation table 142, the DMA controller 20 moves data from the I/O device 18 to the buffers b1˜bn sequentially when receiving a DMA request from the I/O device 18. For example, when the buffer b1 is full, the DMA controller 20 then outputs a first interrupt to the buffer controller 12 and moves data from the I/O device 18 to the next buffer b2, and so on. In embodiments of the invention, there is no need to stop DMA controller, when each buffer is full, such that data transmission interrupts are prevented.

In step S30, the buffer controller 12 detects free buffers in the buffer ring recorded in the allocation table 142 when receiving the first interrupt from the DMA controller 20, wherein the free buffers are all buffers in the buffer ring excluding those with data moved in by the DMA controller 20 not yet processed by the buffer controller 12. Further, the each buffer with unprocessed data would turn into a free buffer again after processing by the buffer controller.

Next, in step S40, the buffer controller 12 allocates at least one new buffer to the buffer ring when the number AF of the detected free buffers in the buffer ring 144 is less than a first threshold value AL. The number AF of the detected free buffers less than the first threshold value AL means that the buffer controller 12, such as a central processing unit (CPU), cannot consume data as fast as the DMA controller 20 can move data to the buffers in the buffer ring 144, such that some data may be overwritten by new data. Thus, in this method, the buffer controller 12 adds at least one buffer descriptor, recording the new buffer to the allocation table 142, thereby increasing the number of the buffers in the buffer ring in order to prevent data been overwritten.

Next, in step S50, the buffer controller 12 releases at least one new buffer from the buffer ring 144 when the number AF of the detected free buffers in the buffer ring 144 exceeds a second threshold value AH. In the invention, the second threshold value AH exceeds the first threshold value AL. The number AF of the detected free buffers exceeded the first threshold value AH means that the buffers controller 12, such as a central processing unit, can consume the data faster than the DMA controller 20 can move data to the buffers in the buffer ring, such that certain free buffers can be released. Thus, in this method, the buffer controller 12 removes at least one buffer descriptor recording the corresponding buffers from the allocation table 142, thereby reducing the number of the buffers in the buffer ring 144.

Therefore, the buffer allocation method of this embodiment of the invention can dynamically adjust the number of DMA buffers, such that the disadvantage of the related art is eliminated and memory utilization is improved.

### Second Embodiment

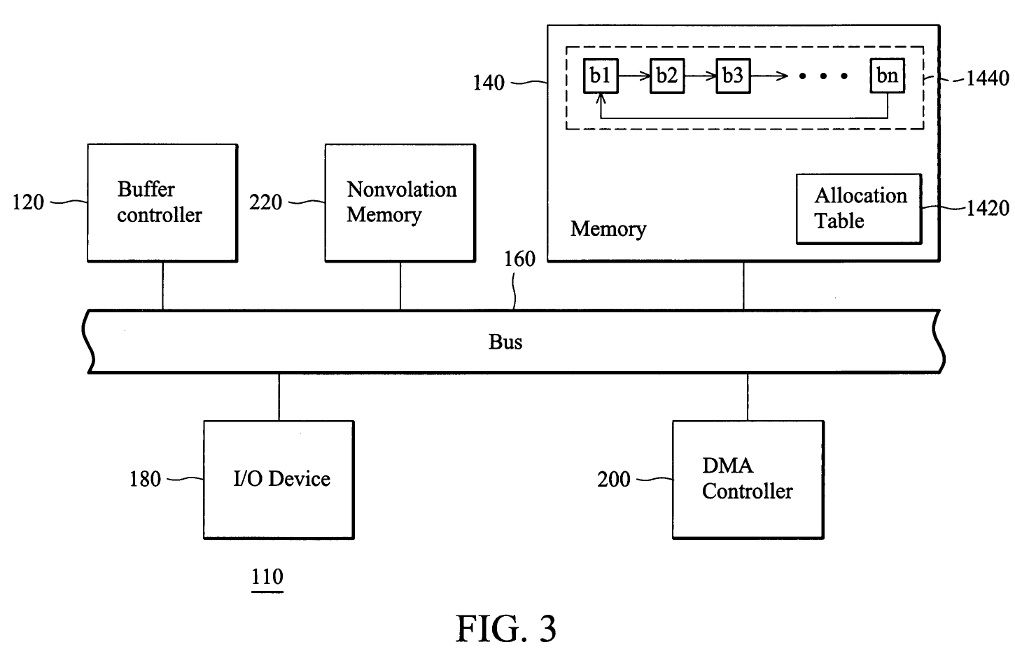

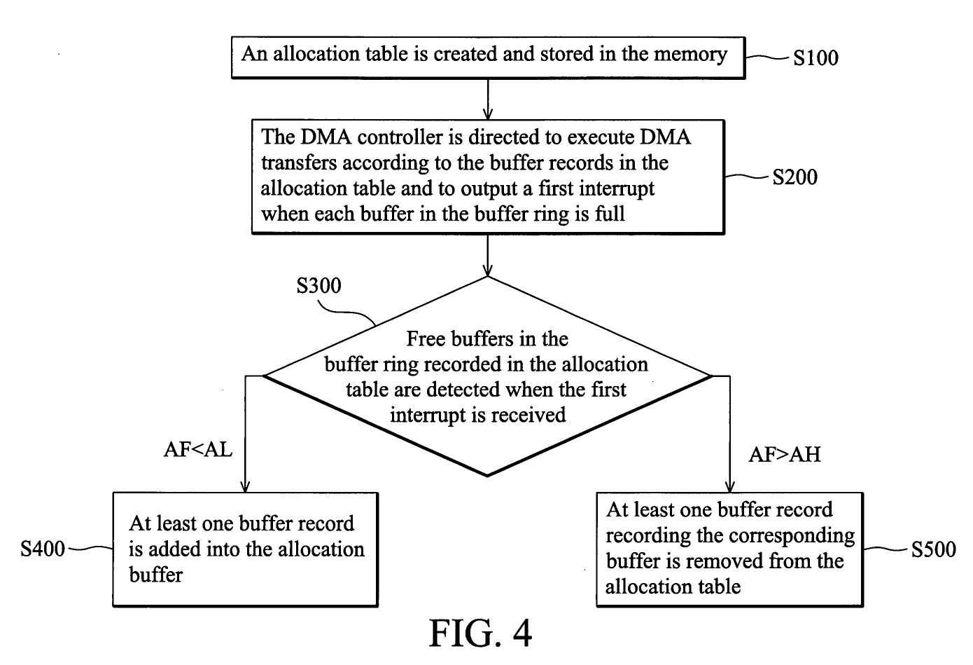

FIG. 3 is a schematic diagram of an electronic device according to a second embodiment of the invention. FIG. 4 is a flowchart of the dynamical allocation method for DMA buffers according to a second embodiment of the invention. The allocation method according to the second embodiment of the invention is described in the following, with reference to FIGS. 3 and 4.

As shown in FIG. 3, the electronic device 110 comprises a buffer controller 112, a memory 114, a bus 160, a nonvolatile memory 220 and a DMA controller 200. For example, the electronic device 110 can be a mobile phone, a personal digital assistant (PDA) and the like. The input/output (I/O) device 180 is coupled to the bus 160 through an universal serial bus (USB) interface, a network interface, an IrDA (Infrared Data Association) interface or similar. The bus 160 is coupled to the buffer controller 120, the memory 140, the DMA controller 200, the nonvolatile memory 220 and the I/O device 180. In this embodiment, the buffer controller 120 can be a processor, central processing unit (CPU) and the like. The nonvolatile memory 220 can be a read only memory (ROM) storing a computer program which when executed by the buffer controller 120, such as a central processing unit (CPU), performs the method of allocating direct memory access (DMA) buffers.

In step S100, an allocation table 1420 is created and stored in the memory 140, the allocation table 1420 comprises buffer records with addresses and size of the allocated buffers b1˜bn, and the allocated buffers b1˜bn in the allocation table 1420 are linked in a buffer ring 1440. Namely, the buffers b1˜bn are linked sequentially, and the final buffer bn is linked to the first buffer b1. For example, the allocation table 1420 comprises a plurality of records, and each record corresponds to a buffer in the memory 140. Each record is a data block that describes a DMA transfer, such as the number of data to move, the source and destination addresses, a pointer to the next record and the like.

In step S200, the DMA controller 200 is directed to execute DMA transfers according to the buffer records in the allocation table 1420 and to output a first interrupt when each buffer in the buffer ring 1440 is full. According to the buffer records in allocation table 1420, the DMA controller 200 moves data from the I/O device 180 to the buffers b1˜bn sequentially. For example, when the buffer b1 is full, the DMA controller 20 then outputs a first interrupt and then moves data from the I/O device 18 to the next buffer b2, and so on. Thus, in this method, DMA controller 200 is not required to stop moving data when each buffer is full, such that data transmission interrupts are prevented.

In step S300, free buffers in the buffer ring 1440 recorded in the allocation table 1420 are detected when the first interrupt is received, wherein the free buffers are the all buffers in the buffer ring 1440 excluding those with data moved thereto by the DMA controller 200 not yet processed by the buffer controller 120, such as a CPU. Further, each buffer with unprocessed data becomes a free buffer again after processing by the buffer controller.

In step S400, at least one buffer record is added into the allocation buffer 1420 when the number AF of the detected free buffers in the buffer ring is less than a first threshold value AL. The number AF of the detected free buffers is less than the first threshold value AL means that the buffer controller 120, such as a central processing unit, cannot consume the data as fast as the DMA controller 200 can move data to the buffers in the buffer ring, such that some data may be overwritten by new data. Thus, in this method at least one buffer record recording the new buffer is added to the allocation table 142, thereby increasing the number of the buffers in the buffer ring 1440 in order to prevent data from being overwritten.

In step S500, at least one buffer record recording the corresponding buffer is removed from the allocation table 1420 when the number AF of the detected free buffers in the buffer ring exceeds a second threshold value AH, wherein the second threshold value AH exceeds the first threshold value AL. The number AF of detected free buffers in excess of the first threshold value AH indicates that the buffer controller 120, such as a central processing unit, can process the data faster than the DMA controller 200 can move data to the buffers in the buffer ring, such that some free buffers can be released. Thus, in this method, at least one buffer record recording the corresponding buffer is removed from the allocation table 1420, thereby reducing the number of the buffers in the buffer ring.

Therefore, the buffer allocation method of embodiments of the invention can dynamically adjust the number of DMA buffers, such that the disadvantage of the related art is eliminated and memory utilization is improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A dynamic allocation method for direct memory access (DMA) buffers, comprising:
directing a DMA controller to move data from an input/output (I/O) device to buffers linked in a buffer ring;
detecting free buffers in the buffer ring when the each buffer is full; and
allocating at least one new buffer to the buffer ring when the number of the detected free buffers is less than a first threshold value.

2. The method as claimed in claim 1, further comprising releasing at least one buffer from the buffer ring when the number of the detected free buffers exceeds a second threshold value, wherein the second threshold value exceeds the first threshold value.

3. The method as claimed in claim 2, further comprising allocating the buffers linked in the buffer ring in a memory.

4. The method as claimed in claim 3, wherein the free buffers are the all buffers in the buffer ring excluding those with data moved thereto by the DMA controller not yet processed by a central processing unit.

5. The method as claimed in claim 4, further comprising directing the DMA controller to output a first interrupt and to move data to the next buffer in the buffer ring, when each buffer in the buffer ring is full.

6. The method as claimed in claim 5, wherein the free buffers in the buffer ring are detected when receiving the first interrupt from the DMA controller.

7. An electronic device capable of allocating buffers dynamically, comprising:
a memory storing an allocation table with a plurality of buffer records, wherein each buffer record relates to a corresponding buffer in the memory and comprises the address and the size of the corresponding buffer and a point linked to the next record;
a DMA controller transferring data between the buffers and an input/output (I/O) device according to the allocation table, and outputting a first interrupt when each buffer in the memory is full; and
a buffer controller detecting free buffers recorded in the allocation table when receiving the first interrupt, and adding at least one buffer record into the allocation table when the number of the detected free buffers is less than a first threshold value.

8. The electronic device as claimed in claim 7, wherein the buffer controller removes at least one buffer record from the allocation table when the number of detected free buffers exceeds a second threshold value, and the second threshold value exceeds the first threshold value.

9. The electronic device as claimed in claim 8, wherein the free buffers are all buffers in the buffer ring excluding those with data moved thereto by the DMA controller not yet processed by the buffer controller.

10. The electronic device as claimed in claim 9, wherein the buffers allocated in the allocation table are linked in a buffer ring.

11. The electronic device as claimed in claim 10, wherein the buffer controller creates and stores the allocation table in the memory.

12. The electronic device as claimed in claim 11, the buffer controller directs the DMA controller to execute DMA transfers according to the allocation table.

13. The electronic device as claimed in claim 12, wherein the DMA controller moves data from the I/O device to the buffers recorded in the allocation table, and when each buffer in the buffer ring is full, the DMA buffer outputs the first interrupt to the buffer controller and moves data to the next buffer in the buffer ring.

14. The electronic device as claimed in claim 7, wherein the buffer controller is a central processing unit (CPU) or an integrated circuit.

15. A machine-readable storage medium for storing a computer program which when executed performs a method of allocating directly memory access (DMA) buffers, the method comprising the steps of:
directing the DMA controller to execute DMA transfers according to a plurality of buffer records in an allocation table, wherein each buffer record corresponds to a buffer in a memory, and the buffers corresponding to the buffer records are linked in a buffer ring;
detecting free buffers in the buffer ring when receiving a first interrupt; and
adding at least one new buffer record in the allocation table to increase the number of buffers in the buffer ring when the number of detected free buffers is less than a first threshold value.

16. The machine-readable storage medium as claimed in claim 15, wherein the method further comprise removing at least one of the buffer records from the allocation table to reduce the number of the buffers in the buffer ring when the number of detected free buffers exceeds a second threshold value, and the second threshold value exceeds the first threshold value.

17. The machine-readable storage medium as claimed in claim 15, wherein the free buffers are all buffers in the buffer ring excluding those with data moved thereto by the DMA controller not yet processed by a central processing unit.

18. The machine-readable storage medium as claimed in claim 15, wherein the method further comprising:
creating and storing the allocation table in the memory; and
directing the DMA controller to output the first interrupt when each buffer is full.

19. The machine-readable storage medium as claimed in claim 15, wherein each buffer record comprises the address and the size of the corresponding buffer and a point linked to the next record.

20. The machine-readable storage medium as claimed in claim 18, wherein the machine-readable storage medium is a nonvolatile memory.
